(19) United States
(12) Patent Application Publication
(10) Pub. No.: US 2026/0082197 A1
(43) Pub. Date: Mar. 19, 2026

(54) WARNING AREA FOR PUBLIC WARNING SYSTEM

(71) Applicant: Samsung Electronics Co., Ltd., Suwon-si (KR)

(72) Inventors: Shiyang Leng, Little Elm, TX (US); Anil Agiwal, McKinney, TX (US); Kyeongin Jeong, Frisco, TX (US)

(21) Appl. No.: 19/316,978

(22) Filed: Sep. 2, 2025

Related U.S. Application Data
(60) Provisional application No. 63/695,730, filed on Sep. 17, 2024.
(60) Provisional application No. 63/704,283, filed on Oct. 7, 2024.

(51) Int. Cl. H04W 4/90

(52) U.S. Cl. CPC H04W 4/90

(57) ABSTRACT

Disclosed are signalling design and procedure to support geo-fencing functionality for the public warning system that includes the earthquake and tsunami warning system (ETWS). The ETWS warning message may be targeted to UEs in a geographical area smaller than the cell coverage area of a non-terrestrial network (NTN). A UE may monitor one or more paging occasions to receive an indication of an ETWS notification from a base station. The UE acquires from the base station system information containing the ETWS notification in response to receiving the indication of the ETWS notification. The UE determines warning area coordinates and a warning message associated with the ETWS notification based on the system information. The UE determines a geographic location of the UE and determines whether to indicate the content of the warning message to a user of the UE based on the warning area coordinates and the UE's geographic location.

### CROSS-REFERENCE TO RELATED APPLICATIONS

This application claims the benefit of priority from U.S. Provisional Application No. 63/695,730 entitled “WARNING AREA FOR PUBLIC WARNING SYSTEM,” filed on Sep. 17, 2024, and U.S. Provisional Application No. 63/704,283 entitled “WARNING AREA FOR PUBLIC WARNING SYSTEM,” filed on Oct. 7, 2024, all of which are incorporated herein by reference in their entirety.

### TECHNICAL FIELD

This disclosure relates generally to a wireless communication system, and more particularly to techniques for signaling and implementing a warning area or geo-fencing for the public warning system that includes the earthquake and tsunami warning system (ETWS).

### BACKGROUND

3GPP (Third-Generation Partnership Project) has developed technical specifications and standards to define the new 5G radio-access technology, known as 5G NR (New Radio) and the upcoming technology currently coined “6G.” In 3GPP Release 17 specification, 5G NR introduces support for vertical functionality of a non-terrestrial network (NTN). An NTN provides non-terrestrial NR access to a user equipment (UE) by means of an NTN payload, e.g. a satellite, and an NTN Gateway as specified in 3GPP TS 38.300 v18.0.0 (5G; NR; NR and NG-RAN Overall Descriptions; Stage 2) and 3GPP TS 38.331 v18.0.0 (5G; NR; Radio Resource Control (RRC); Protocol specification). The NTN payload transparently forwards the radio protocol received from the UE over the service link (i.e. wireless link between the NTN payload and UE) to the NTN Gateway (via the feeder link, i.e. wireless link between the NTN Gateway and the NTN payload) and vice-versa. With its capabilities to deliver wide coverage and reliable connectivity, NTN is envisioned to provide ubiquitous service availability and continuity. For instance, NTN can support communication services in unserved areas beyond the reach of conventional terrestrial networks (TN), in underserved areas with limited communication services, for devices and passengers on board moving platforms, and in future railway/maritime/aeronautical communication scenarios, etc. To support NTN in 5G NR, features are continuously being introduced or enhanced to accommodate the nature of radio access to NTN that are different from TN, such as large cell coverage, long propagation delay, and non-static cell/satellite.

Public warning system (PWS) provides a service that allows a network to distribute warning messages on behalf of public authority. For example, PWS enables the distribution of earthquake and tsunami warning system (ETWS), commercial mobile alert service (CMAS), etc. In NTN, satellite footprint and NTN cell covers a large area which is usually much larger than those covered by TN cells. However, the warning message may be intended for an area smaller than an NTN cell coverage. For example, the broadcast information may be specific to UEs within an intended area, such as a country, in a procedure referred to as geo-fencing. Currently, CWAS has the capability to provide warning area coordinates for geo-fencing. The UE may compare its location with the geographic area indicated by the warning area coordinates and determine whether to present the warning message to a user of the UE. However, ETWS does not support geo-fencing functionality. As such, it is desired to design signalling and procedure to support geo-fencing for ETWS in NTN.

While the background section provides a motivation for the present disclosure, the description set forth in the background section should not be assumed to be prior art merely because it is set forth in the background section. Rather, the background section may describe aspects or embodiments of the present disclosure.

### SUMMARY

An aspect of the present disclosure provides for a user equipment (UE) in a wireless network. The UE includes a processor configured to monitor one or more paging occasions to receive an indication of an ETWS notification from a base station. The processor is also configured to acquire, from the base station, system information containing the ETWS notification in response to receiving the indication of the ETWS notification. The processor is further configured to determine warning area coordinates and a warning message associated with the ETWS notification based on the system information; determine a geographic location of the UE; and determine whether to indicate content of the warning message to a user of the UE based on the warning area coordinates and the geographic location of the UE.

In one embodiment of the UE, the system information includes one or more segments of the ETWS notification. Each segment of the ETWS notification includes a segment of the warning message and a segment of the warning area coordinates.

In one embodiment of the UE, to acquire the system information containing the ETWS notification, the processor is configured to receive the one or more segments of the ETWS notification. Furthermore, to determine the warning area coordinates and the warning message associated with the ETWS notification based on the system information, the processor is configured to assemble one or more segments of the warning message to generate a complete warning message. The processor is also configured to assemble one or more segments of the warning area coordinates to generate a complete set of warning area coordinates.

In one embodiment of the UE, to assemble the one or more segments of the warning area coordinates, the processor is configured to store the one or more segments of the warning area coordinates when receiving the respective one or more segments of the ETWS notification. The processor is also configured to generate the complete set of warning area coordinates from the one or more stored segments of the warning area coordinates when all segments of the warning area coordinates are received. The processor is further configured to forward the complete set of warning area coordinates to an upper layer of the UE and to discard the one or more stored segments of the warning area coordinates.

In one embodiment of the UE, the warning area coordinates indicate a geographical area where the warning message associated with the ETWS notification is valid.

In one embodiment of the UE, to determine whether to indicate the content of the warning message to the user, the processor is configured to determine a geographical area of the warning message based on the warning area coordinates. The processor is also configured to determine that the geographic location of the UE is unknown. The processor is further configured to indicate the content of the warning message to the user of the UE.

In one embodiment of the UE, to determine whether to indicate the content of the warning message to the user, the processor is configured to determine a geographical area of the warning message based on the warning area coordinates. The processor is also configured to determine that the geographic location of the UE is inside the geographical area of the warning message. The processor is further configured to indicate the content of the warning message to the user of the UE.

In one embodiment of the UE, to determine whether to indicate the content of the warning message to the user, the processor is configured to determine a geographical area of the warning message based on the warning area coordinates. The processor is also configured to determine that the geographic location of the UE is outside the geographical area of the warning message. The processor is further configured to refrain from indicating the content of the warning message to the user of the UE.

In one embodiment of the UE, the ETWS notification includes an indication to activate an emergency user alert or to activate a popup display on the UE. Further, to determine whether to indicate the content of the warning message to the user, the processor is configured to determine a geographical area of the warning message based on the warning area coordinates. The processor is also configured to determine that the geographic location of the UE is inside the geographical area of the warning message or that the geographic location of the UE is unknown. The processor is further configured to alert the user of the UE to an ETWS emergency or to popup a display of the warning message on the UE.

In one embodiment of the UE, the ETWS notification includes an indication to activate an emergency user alert or to activate a popup display on the UE. Further, to determine whether to indicate the content of the warning message to the user, the processor is configured to determine a geographical area of the warning message based on the warning area coordinates. The processor is also configured to determine that the geographic location of the UE is outside the geographical area of the warning message. The processor is further configured to refrain from alerting the user of the UE to an ETWS emergency or to refrain from displaying the warning message on the UE.

An aspect of the present disclosure provides for a method performed by a UE in a wireless network. The method includes the UE monitoring one or more paging occasions to receive an indication of an ETWS notification from a base station. The method also includes the UE acquiring, from the base station, system information containing the ETWS notification in response to receiving the indication of the ETWS notification. The method further includes the UE determining warning area coordinates and a warning message associated with the ETWS notification based on the system information; determining a geographic location of the UE; and determining whether to indicate content of the warning message to a user of the UE based on the warning area coordinates and the geographic location of the UE.

In one embodiment of the method, the system information includes one or more segments of the ETWS notification. Each segment of the ETWS notification includes a segment of the warning message and a segment of the warning area coordinates.

In one embodiment of the method, when acquiring the system information containing the ETWS notification, the method includes the UE receiving the one or more segments of the ETWS notification. Furthermore, when determining the warning area coordinates and the warning message, the method includes the UE assembling one or more segments of the warning message to generate a complete warning message. The method also includes the UE assembling one or more segments of the warning area coordinates to generate a complete set of warning area coordinates.

In one embodiment of the method, when assembling one or more segments of the warning area coordinates, the method includes the UE storing the one or more segments of the warning area coordinates when receiving the respective one or more segments of the ETWS notification. The method also includes the UE generating the complete set of warning area coordinates from the one or more stored segments of the warning area coordinates when all segments of the warning area coordinates are received. The method further includes the UE forwarding the complete set of warning area coordinates to an upper layer of the UE and discarding the one or more stored segments of the warning area coordinates.

In one embodiment of the method, the warning area coordinates indicate a geographical area where the warning message associated with the ETWS notification is valid.

In one embodiment of the method, when determining whether to indicate the content of the warning message to the user of the UE, the method includes the UE determining a geographical area of the warning message based on the warning area coordinates. The method also includes the UE determining that the geographic location of the UE is unknown. The method further includes the UE indicating the content of the warning message to the user of the UE.

In one embodiment of the method, when determining whether to indicate the content of the warning message to the user of the UE, the method includes the UE determining a geographical area of the warning message based on the warning area coordinates. The method also includes the UE determining that the geographic location of the UE is inside the geographical area of the warning message. The method further includes the UE indicating the content of the warning message to the user of the UE.

In one embodiment of the method, when determining whether to indicate the content of the warning message to the user of the UE, the method includes the UE determining a geographical area of the warning message based on the warning area coordinates. The method also includes the UE determining that the geographic location of the UE is outside the geographical area of the warning message. The method further includes the UE refraining from indicating content of the warning message to the user of the UE.

In one embodiment of the method, the ETWS notification includes an indication to activate an emergency user alert or to activate a popup display on the UE. Further, when determining whether to indicate the content of the warning message to the user of the UE, the method includes the UE determining a geographical area of the warning message based on the warning area coordinates. The method also includes the UE determining that the geographic location of the UE is inside the geographical area of the warning message or that the geographic location of the UE is unknown. The method further includes the UE alerting the user of the UE to an ETWS emergency or popping up a display of the warning message on the UE.

In one embodiment of the method, the ETWS notification includes an indication to activate an emergency user alert or to activate a popup display on the UE. Further, when determining whether to indicate the content of the warning message to the user of the UE, the method includes the UE determining a geographical area of the warning message based on the warning area coordinates. The method also includes the UE determining that the geographic location of the UE is outside the geographical area of the warning message. The method further includes the UE refraining from alerting the user of the UE to an ETWS emergency or refraining from displaying the warning message on the UE.

### BRIEF DESCRIPTION OF THE DRAWINGS

FIG. 1 shows an example of a wireless network in accordance with an embodiment.

FIG. 2A shows an example of a wireless transmit path in accordance with an embodiment.

FIG. 2B shows an example of a wireless receive path in accordance with an embodiment.

FIG. 3A shows an example of a user equipment (“UE”) in accordance with an embodiment.

FIG. 3B shows an example of a base station (“BS”) in accordance with an embodiment.

FIG. 4 shows a procedure for the UE to receive ETWS primary or secondary notification with warning area information in accordance with an embodiment.

FIG. 5 shows a procedure for the UE to acquire PWS based on the intended geographic area information of the PWS and the UE's geographic location in accordance with an embodiment.

FIG. 6 shows an example process 600 for a UE to receive ETWS notification including warning area coordinates to support geo-fencing functionality of the ETWS notification in accordance with an embodiment.

In one or more implementations, not all the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in numerous ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied using a multitude of different approaches. The examples in this disclosure are based on the current 5G NR systems, 5G-Advanced (5G-A) and further improvements and advancements thereof and to the upcoming 6G communication systems. However, under various circumstances, the described embodiments may also be implemented in any device, system or network that is capable of transmitting and receiving radio frequency (RF) signals according to other technologies, such as the 3G and 4G systems, or further implementations thereof. For example, the principles of the disclosure may apply to Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), enhancements of 5G NR, AMPS, or other known signals that are used to communicate within a wireless, cellular or IoT network, such as one or more of the above-described systems utilizing 3G, 4G, 5G, 6G or further implementations thereof. The technology may also be relevant to and may apply to any of the existing or proposed IEEE 802.11 standards, the Bluetooth standard, and other wireless communication standards.

Wireless communications like the ones described above have been among the most commercially acceptable innovations in history. Setting aside the automated software, robotics, machine learning techniques, and other software that automatically use these types of communication devices, the sheer number of wireless or cellular subscribers continues to grow. A little over a year ago, the number of subscribers to the various types of communication services had exceeded five billion. That number has long since been surpassed and continues to grow quickly. The demand for services employing wireless data traffic is also rapidly increasing, in part due to the growing popularity among consumers and businesses of smart phones and other mobile data devices, such as tablets, “note pad” computers, net books, eBook readers, and dedicated machine-type devices. It should be self-evident that, to meet the high growth in mobile data traffic and support new applications and deployments, improvements in radio interface efficiency and coverage are of paramount importance.

To continue to accommodate the growing demand for the transmission of wireless data traffic that has dramatically increased over the years, and to facilitate the growth and sophistication of so-called “vertical applications” (that is, code written or produced in accordance with a user's or entities' specific requirements to achieve objectives unique to that user or entity, including enterprise resource planning and customer relationship management software, for example), 5G communication systems have been developed and are currently being deployed commercially. 5G Advanced, as defined in 3GPP Release 18, is yet a further upgrade to aspects of 5G and has already been introduced as an optimization to 5G in certain countries. Development of 5G Advanced is well underway. The development and enhancements of 5G also can accord processing resources greater overall efficiency, including, by way of example, in high-intensive machine learning environments involving precision medical instruments, measurement devices, robotics, and the like. Due to 5G and its expected successor technologies, access to one or more application programming interfaces (APIs) and other software routines by these devices are expected to be more robust and to operate at faster speeds.

Among other advantages, 5G can be implemented to include higher frequency bands, including in particular 28 GHz or 60 GHz frequency bands. More generally, such frequency bands may include those above 6 GHz bands. A key benefit of these higher frequency bands are potentially significantly superior data rates. One drawback is the requirement in some cases of line-of-sight (LOS), the difficulty of higher frequencies to penetrate barriers between the base station and UE, and the shorter overall transmission range. 5G systems rely on more directed communications (e.g., using multiple antennas, massive multiple-input multiple-output (MIMO) implementations, transmit and/or receive beamforming, temporary power increases, and like measures) when transmitting at these mmWave (mmW) frequencies. In addition, 5G can beneficially be transmitted using lower frequency bands, such as below 6 GHz, to enable more robust and distant coverage and for mobility support (including handoffs and the like). As noted above, various aspects of the present disclosure may be applied to 5G deployments, to 6G systems currently under development, and to subsequent releases. The latter category may include those standards that apply to the THz frequency bands. To decrease propagation loss of the radio waves and increase transmission distance. as noted in part, emerging technologies like MIMO, Full Dimensional MIMO (FD-MIMO), array antenna, digital and analog beamforming, large scale antenna techniques and other technologies are discussed in the various 3GPP-based standards that define the implementation of 5G communication systems.

In addition, in 5G communication systems, development for system network improvement is underway or has been deployed based on advanced small cells, cloud Radio Access Networks (RANs), ultra-dense networks, device-to-device (D2D) communication, wireless backhaul, moving networks, cooperative communication, Coordinated Multi-Points (CoMP), reception-end interference cancellation, and the like. As exemplary technologies like neural-network machine learning, unmanned or partially-controlled electric vehicles, or hydrogen-based vehicles begin to emerge, these 5G advances are expected to play a potentially significant role in their respective implementations. Further advanced access technologies under the umbrella of 5G that have been developed or that are under development include, for example: advanced coding modulation (ACM) schemes using Hybrid frequency-shift-keying (FSK), frequency quadrature amplitude modulation (FQAM) and sliding window superposition coding (SWSC); and advanced access technologies using filter bank multi-carrier (FBMC), non-orthogonal multiple access (NOMA), and sparse code multiple access (SCMA).

Also under development are the principles of the 6G technology, which may roll out commercially at the end of decade or even earlier. 6G systems are expected to take most or all the improvements brought by 5G and improve them further, as well as to add new features and capabilities. It is also anticipated that 6G will tap into uncharted areas of bandwidth to increase overall capacities. As noted, principles of this disclosure are expected to apply with equal force to 6G systems, and beyond.

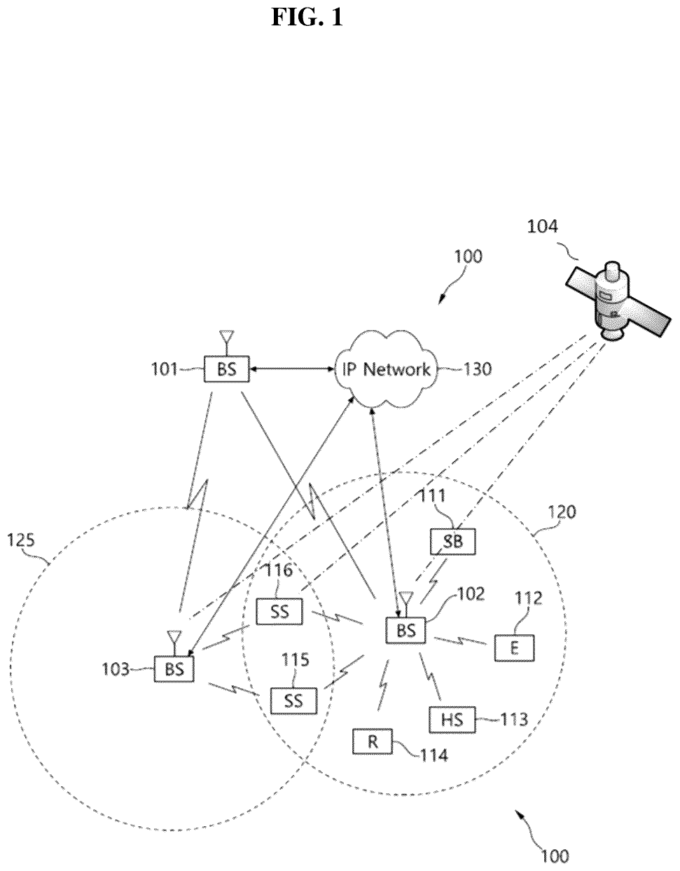

FIG. 1 shows an example of a wireless network 100 in accordance with an embodiment. The embodiment of the wireless network 100 shown in FIG. 1 is for purposes of illustration only. Other embodiments of the wireless network 100 can be used without departing from the scope of this disclosure. Initially it should be noted that the nomenclature may vary widely depending on the system. For example, in FIG. 1, the terminology “BS” (base station) may also be referred to as an eNodeB (eNB), a gNodeB (gNB), or at the time of commercial release of 6G, the BS may have another name. For the purposes of this disclosure, BS and gNB are used interchangeably. Thus, depending on the network type, the term ‘gNB’ can refer to any component (or collection of components) configured to provide remote terminals with wireless access to a network, such as base transceiver station, a radio base station, transmit point (TP), transmit-receive point (TRP), a ground gateway, an airborne gNB, a satellite system, mobile base station, a macrocell, a femtocell, a WiFi access point (AP) and the like. Referring back to FIG. 1, the network 100 includes BSs (or gNBs) 101, 102, and 103. BS 101 communicates with BS 102 and BS 103. BSs may be connected by way of a known backhaul connection, or another connection method, such as a wireless connection. BS 101 also communicates with at least one Internet Protocol (IP)-based network 130. Network 130 may include the Internet, a proprietary IP network, or another network.

Similarly, depending on the network 100 type, other well-known terms may be used instead of “user equipment” or “UE,” such as “mobile station,” “subscriber station,” “remote terminal,” “wireless terminal,” or “user device.” For the sake of convenience, the terms “user equipment” and “UE” are used interchangeably with “subscriber station” in this patent document to refer to remote wireless equipment that wirelessly accesses a gNB, whether the UE is a mobile device (such as a mobile telephone or smartphone) or is normally considered a stationary device (such as a desktop computer, vending machine, appliance, or any device with wireless connectivity compatible with network 100). With continued reference to FIG. 1, BS 102 provides wireless broadband access to the IP network 130 for a first plurality of user equipments (UEs) within a coverage area 120 of the BS 102. The first plurality of UEs includes a UE 111, which may be located in a small business (SB); a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M) like a cell phone, a wireless laptop, a wireless PDA, or the like. The BS 103 provides wireless broadband access to IP network 130 for a second plurality of UEs within a coverage area 125 of the BS 103. The second plurality of UEs includes the UE 115 and the UE 116, which are in both coverage areas 120 and 125. In some embodiments, one or more of the BSs 101-103 may communicate with each other and with the UEs 111-116 using 6G, 5G, long-term evolution (LTE), LTE-A, WiMAX, or other advanced wireless communication techniques.

In FIG. 1, as noted, dotted lines show the approximate extents of the coverage area 120 and 125 of BSs 102 and 103, respectively, which are shown as approximately circular for the purposes of illustration and explanation. It should be clearly understood that coverage areas associated with BSs, such as the coverage areas 120 and 125, may have other shapes, including irregular shapes, depending on the configuration of the BSs. Although FIG. 1 illustrates one example of a wireless network 100, various changes may be made to FIG. 1. For example, the wireless network 100 can include any number of BSs/gNBs and any number of UEs in any suitable arrangement. Also, the BS 101 can communicate directly with any number of UEs and provide those UEs with wireless broadband access to IP network 130. Similarly, each BS 102 or 103 can communicate directly with IP network 130 and provide UEs with direct wireless broadband access to the network 130. Further, gNB 101, 102, and/or 103 can provide access to other or additional external networks, such as external telephone networks or other types of data networks.

As discussed in greater detail below, the wireless network 100 may have communications facilitated via one or more communication satellite(s) 104 that may be in orbit over the earth. The communication satellite(s) 104 can communicate directly with the BSs 102 and 103 to provide network access, for example, in situations where the BSs 102 and 103 are remotely located or otherwise in need of facilitation for network access connections beyond or in addition to traditional fronthaul and/or backhaul connections. The BSs 102 and 103 can also be on board the communication satellite(s) 104. One or more of the UEs (e.g., as depicted by UE 116) may be capable of at least some direct communication and/or localization with the communication satellite(s) 104.

A non-terrestrial network (NTN) refers to a network, or segment of networks using RF resources on board a communication satellite (or unmanned aircraft system platform) (e.g., communication satellite(s) 104). Considering the capabilities of providing wide coverage and reliable service, an NTN is envisioned to ensure service availability and continuity ubiquitously. For instance, an NTN can support communication services in unserved areas that cannot be covered by conventional terrestrial networks, in underserved areas that are experiencing limited communication services, for devices and passengers on board moving platforms, and for future railway/maritime/aeronautical communications, etc.

As described in more detail below, one or more of the UEs 111-116 include circuitry, programing, or a combination thereof for supporting mobility in wireless networks. In certain embodiments, one or more of the BSs 101-103 include circuitry, programing, or a combination thereof to mobility in wireless networks.

It will be appreciated that in 5G systems, the BS 101 may include multiple antennas, multiple radio frequency (RF) transceivers, transmit (TX) processing circuitry, and receive (RX) processing circuitry. The BS 101 also may include a controller/processor, a memory, and a backhaul or network interface. The RF transceivers may receive, from the antennas, incoming RF signals, such as signals transmitted by UEs in network 100. The RF transceivers may down-convert the incoming RF signals to generate intermediate (IF) or baseband signals. The IF or baseband signals are sent to the RX processing circuitry, which generates processed baseband signals by filtering, decoding, and/or digitizing the baseband or IF signals. The RX processing circuitry transmits the processed baseband signals to the controller/processor for further processing.

The controller/processor can include one or more processors or other processing devices that control the overall operation of the BS 101 (FIG. 1). For example, the controller/processor may control the reception of uplink signals and the transmission of downlink signals by the BS 101, the RX processing circuitry, and the TX processing circuitry in accordance with well-known principles. The controller/processor may support additional functions as well, such as more advanced wireless communication functions. For instance, the controller/processor may support beamforming or directional routing operations in which outgoing signals from multiple antennas are weighted differently to effectively steer the outgoing signals in a desired direction. The controller/processor may also support OFDMA operations in which outgoing signals may be assigned to different subsets of subcarriers for different recipients (e.g., different UEs 111-114). Any of a wide variety of other functions may be supported in the BS 101 by the controller/processor including a combination of MIMO and OFDMA in the same transmit opportunity. In some embodiments, the controller/processor may include at least one microprocessor or microcontroller. The controller/processor is also capable of executing programs and other processes resident in the memory, such as an OS. The controller/processor can move data into or out of the memory as required by an executing process.

The controller/processor is also coupled to the backhaul or network interface. The backhaul or network interface allows the BS 101 to communicate with other BSs, devices or systems over a backhaul connection or over a network. The interface may support communications over any suitable wired or wireless connection(s). For example, the interface may allow the BS 101 to communicate over a wired or wireless local area network or over a wired or wireless connection to a larger network (such as the Internet). The interface may include any suitable structure supporting communications over a wired or wireless connection, such as an Ethernet or RF transceiver. The memory is coupled to the controller/processor. Part of the memory may include a RAM, and another part of the memory may include a Flash memory or other ROM.

For purposes of this disclosure, the processor may encompass not only the main processor, but also other hardware, firmware, middleware, or software implementations that may be responsible for performing the various functions. In addition, the processor's execution of code in a memory may include multiple processors and other elements and may include one or more physical memories. Thus, for example, the executable code or the data may be located in different physical memories, which embodiment remains within the spirit and scope of the present disclosure.

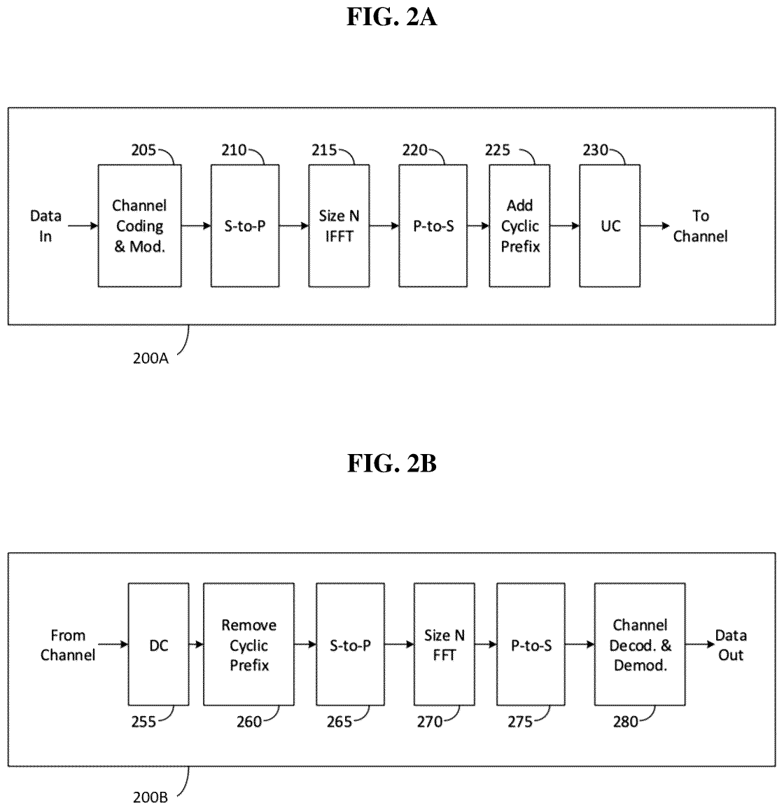

FIG. 2A shows an example of a wireless transmit path 200A in accordance with an embodiment. FIG. 2B shows an example of a wireless receive path 200B in accordance with an embodiment. In the following description, a transmit path 200A may be implemented in a gNB/BS (such as BS 102 of FIG. 1), while a receive path 200B may be implemented in a UE (such as UE 111 (SB) of FIG. 1). However, it will be understood that the receive path 200B can be implemented in a BS and that the transmit path 200A can be implemented in a UE. In some embodiments, the receive path 200B is configured to support the codebook design and structure for systems having 2D antenna arrays as described in some embodiments of the present disclosure. That is to say, each of the BS and the UE include transmit and receive paths such that duplex communication (such as a voice conversation) is made possible. In some embodiments, the transmit path 200A and the receive path 200B is configured to support mobility in wireless networks as described in various embodiments of the present disclosure.

The transmit path 200A includes a channel coding and modulation block 205 for modulating and encoding the data bits into symbols, a serial-to-parallel (S-to-P) conversion block 210, a size N Inverse Fast Fourier Transform (IFFT) block 215 for converting N frequency-based signals back to the time domain before they are transmitted, a parallel-to-serial (P-to-S) block 220 for serializing the parallel data block from the IFFT block 215 into a single datastream (noting that BSs/UEs with multiple transmit paths may each transmit a separate datastream), an add cyclic prefix block 225 for appending a guard interval that may be a replica of the end part of the orthogonal frequency domain modulation (OFDM) symbol (or whatever modulation scheme is used) and is generally at least as long as the delay spread to mitigate effects of multipath propagation. Alternatively, the cyclic prefix may contain data about a corresponding frame or other unit of data. An up-converter (UC) 230 is next used for modulating the baseband (or in some cases, the intermediate frequency (IF)) signal onto the carrier signal to be used as an RF signal for transmission across an antenna.

The receive path 200B essentially includes the opposite circuitry and includes a down-converter (DC) 255 for removing the datastream from the carrier signal and restoring it to a baseband (or in other embodiments an IF) datastream, a remove cyclic prefix block 260 for removing the guard interval (or removing the interval of a different length), a serial-to-parallel (S-to-P) block 265 for taking the datastream and parallelizing it into N datastreams for faster operations, a multi-input size N Fast Fourier Transform (FFT) block 270 for converting the N time-domain signals to symbols into the frequency domain, a parallel-to-serial (P-to-S) block 275 for serializing the symbols, and a channel decoding and demodulation block 280 for decoding the data and demodulating the symbols into bits using whatever demodulating and decoding scheme was used to initially modulate and encode the data in reference to the transmit path 200A.

As a further example, in the transmit path 200A of FIG. 2A, the channel coding and modulation block 205 receives a set of information bits, applies coding (such as a low-density parity check (LDPC) coding), and modulates the input bits (such as with Quadrature Phase Shift Keying (QPSK), Quadrature Amplitude Modulation (QAM), Orthogonal Frequency Domain Multiple Access (OFDMA), or other current or future modulation schemes) to generate a sequence of frequency-domain modulation symbols. The serial-to-parallel block 210 converts (such as de-multiplexes) the serial modulated symbols to parallel data to generate N parallel symbol streams, where as noted, N is the IFFT/FFT size used in the BS 102 and the UE 116 FIG. 1. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 to generate a serial time-domain signal. The add cyclic prefix block 225 inserts a cyclic prefix to the time-domain signal. The up-converter 230 modulates (such as up-converts) the output of the add cyclic prefix block 225 from baseband (or in other embodiments, an intermediate frequency IF) to an RF frequency for transmission via a wireless channel. The signal may also be filtered at baseband before conversion to the RF frequency.

A transmitted RF signal from the BS 102 arrives at the UE 116 after passing through the wireless channel, and reverse operations to those at the BS 102 are performed at the UE 116 (FIG. 1). The down-converter 255 (for example, at UE 116) down-converts the received signal to a baseband or IF frequency, and the remove cyclic prefix block 260 removes the cyclic prefix to generate a serial time-domain baseband signal. The serial-to-parallel block 265 converts or multiplexes the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream. The data stream may then be portioned and processed accordingly using a processor and its associated memory(ies). Each of the BSs 101-103 of FIG. 1 may implement a transmit path 200A that is analogous to transmitting in the downlink to UEs 111-116, Likewise, each of the BSs 101-103 may implement a receive path 200B that is analogous to receiving in the uplink from UEs 111-116. Similarly, to realize bidirectional signal execution, each of UEs 111-116 may implement a transmit path 200A for transmitting in the uplink to BSs 101-103 and each of UEs 111-116 may implement a receive path 200B for receiving in the downlink from gNBs 101-103. In this manner, a given UE may exchange signals bidirectionally with a BS within its range, and vice versa.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation. In addition, although described as using FFT and IFFT, this exemplary implementation is by way of illustration only and should not be construed to limit the scope of this disclosure. For example, other types of transforms, such as Discrete Fourier Transform (DFT) and Inverse Discrete Fourier Transform (IDFT) functions, can be used in lieu of the FFT/IFFT. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions. Additionally, although FIGS. 2A and 2B illustrate examples of wireless transmit and receive paths, various changes may be made to FIGS. 2A and 2B. For example, various components in FIGS. 2A and 2B can be combined, further subdivided, or omitted, and additional components can be added according to particular needs. Also, FIGS. 2A and 2B are meant to illustrate examples of the types of transmit and receive paths that can be used in a wireless network. Any other suitable architectures can be used to support wireless communications in a wireless network. For example, the functions performed by the modules in FIGS. 2A and 2B may be performed by a processor executing the correct code in memory corresponding to each module.

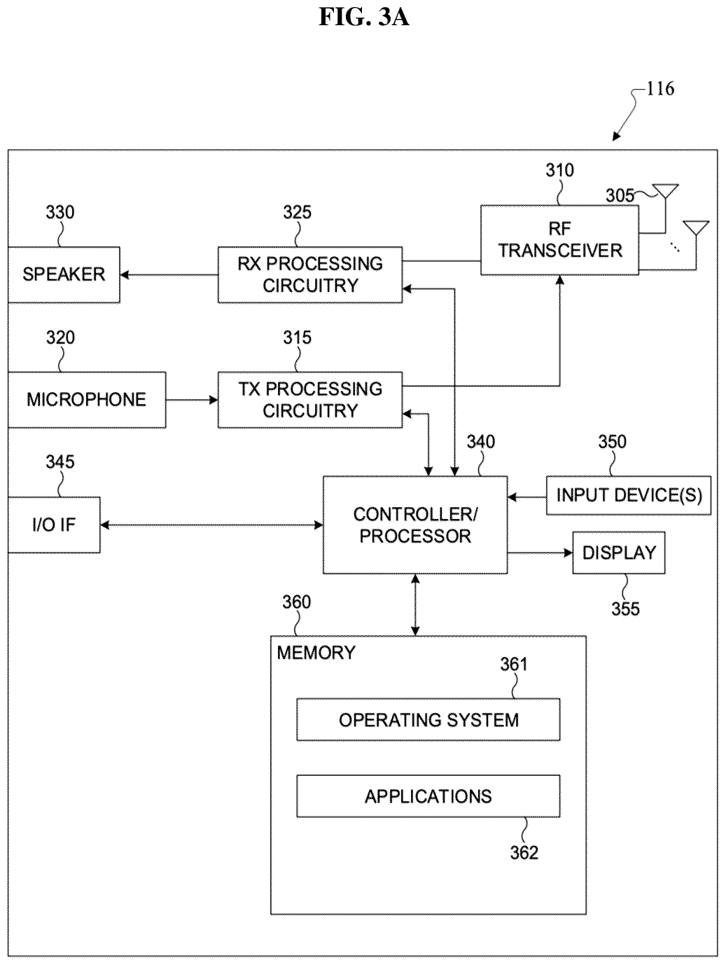

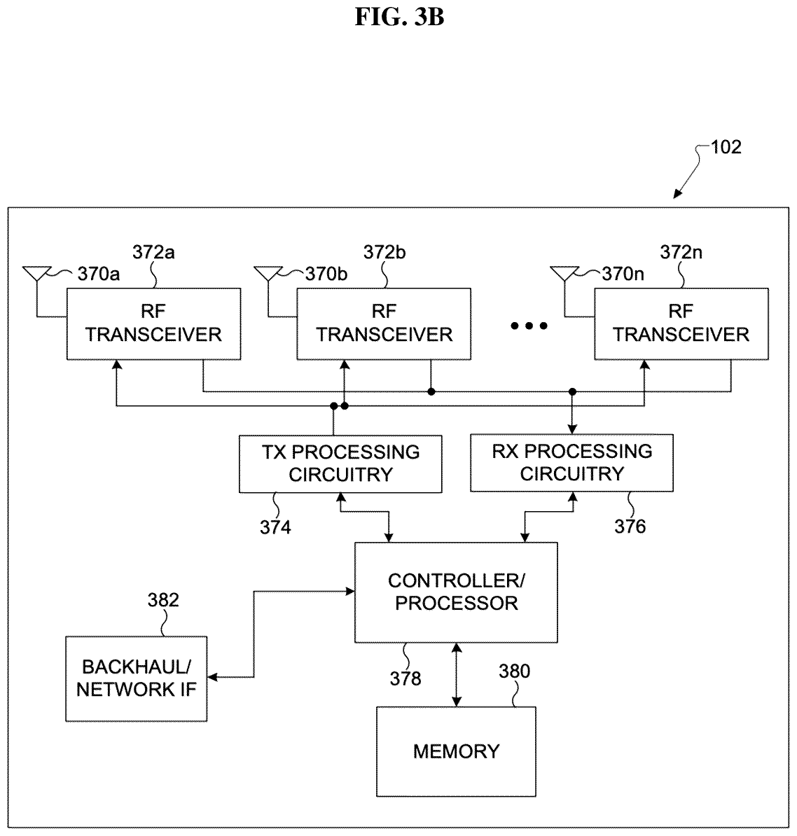

FIG. 3A shows an example of a user equipment (“UE”) 300A (which may be UE 116 in FIG. 1, for example, or another UE) in accordance with an embodiment. It should be underscored that the embodiment of the UE 300A illustrated in FIG. 3A is for illustrative purposes only, and the UEs 111-116 of FIG. 1 can have the same or similar configuration. However, UEs come in a wide variety of configurations, and the UE 300A of FIG. 3A does not limit the scope of this disclosure to any particular implementation of a UE. Referring now to the components of FIG. 3A, the UE 300A includes an antenna 305 (which may be a single antenna or an array or plurality thereof in other UEs), a radio frequency (RF) transceiver 310, transmit (TX) processing circuitry 315 coupled to the RF transceiver 310, a microphone 320, and receive (RX) processing circuitry 325. The UE 300A also includes a speaker 330 coupled to the receive processing circuitry 325, a main processor 340, an input/output (I/O) interface (IF) 345 coupled to the processor 340, a keypad (or other input device(s)) 350, a display 355, and a memory 360 coupled to the processor 340. The memory 360 includes a basic operating system (OS) program 361 and one or more applications 362, in addition to data. In some embodiments, the display 355 may also constitute an input touchpad and in that case, it may be bidirectionally coupled with the processor 340.

The RF transceiver may include more than one transceiver, depending on the sophistication and configuration of the UE. The RF transceiver 310 receives from antenna 305, an incoming RF signal transmitted by a BS of the network 100. The RF transceiver sends and receives wireless data and control information. The RF transceiver is operable coupled to the processor 340, in this example via TX processing circuitry 315 and RF processing circuitry 325. The RF transceiver 310 may thereupon down-convert the incoming RF signal to generate an intermediate frequency (IF) or baseband signal. In some embodiments, the down-conversion may be performed by another device coupled to the transceiver. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as in the context of a voice call) or to the main processor 340 for further processing (such as for web browsing data or any number of other applications). The TX processing circuitry 315 receives analog or digital voice data from the microphone 320 or, in other cases, TX processing circuitry 315 may receive other outgoing baseband data (such as web data, e-mail, or interactive video game data) from the main processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305. The same operations may be performed using alternative methods and arrangements without departing from the spirit or scope of the present disclosure.

The main processor 340 can include one or more processors or other processing devices and execute the basic OS program 361 stored in the memory 360 to control the overall operation of the UE 116. For example, the main processor 340 can control the reception of forward channel signals and the transmission of reverse channel signals by the RF transceiver 310, the RX processing circuitry 325, and the TX processing circuitry 315 in accordance with well-known principles. In some embodiments, the main processor 340 includes at least one microprocessor or microcontroller. The transceiver 310 is coupled to the processor 340, directly or through intervening elements. The main processor 340 is also capable of executing other processes and programs resident in the memory 360 as described in embodiments of the present disclosure. The main processor 340 can move data into or out of the memory 360 as required by an executing process. In some embodiments, the main processor 340 is configured to execute the applications 362 based on the OS program 361 or in response to signals received from BSs or an operator of the UE. For example, the main processor 340 may execute processes to support mobility in wireless networks as described in various embodiments of the present disclosure. The main processor 340 is also coupled to the I/O interface 345, which provides the UE 300A with the ability to connect to other devices such as laptop computers and handheld computers. The I/O interface 345 is the communication path between these accessories and the main processor 340. The main processor 340 is also coupled to the keypad 350 and the display unit 355. The operator of the UE 300A can use the keypad 350 to enter data into the UE 300A. The display 355 may be a liquid crystal display or other display capable of rendering text and/or at least limited graphics, such as from web sites. The memory 360 is coupled to the main processor 340. Part of the memory 360 can include a random-access memory (RAM), and another part of the memory 360 can include a Flash memory or other read-only memory (ROM).

The UE 300A of FIG. 3A may also include additional or different types of memory, including dynamic random-access memory (DRAM), non-volatile flash memory, static RAM (SRAM), different levels of cache memory, etc. While the main processor 340 may be a complex-instruction set computer (CISC)-based processor with one or multiple cores, it was noted that in other embodiments, the processor may include a plurality of processors. The processor(s) may also include a reduced instruction set computer (RISC)-based processor. The various other components of UE 300A may include separate processors, or they may be controlled in part or in full by firmware or middleware. For example, any one or more of the components of UE 300A may include one or more digital signal processors (DSPs) for executing specific tasks, one or more field programmable gate arrays (FPGAs), one or more programmable logic devices (PLDs), one or more application specific integrated circuits (ASICs) and/or one or more systems on a chip (SoC) for executing the various tasks discussed above. In some implementations, the UE 300A may rely on middleware or firmware, updates of which may be received from time to time. For smartphones and other UEs whose objective is typically to be compact, the hardware design may be implemented to reflect this smaller aspect ratio. The antenna(s) may stick out of the device, or in other UEs, the antenna(s) may be implanted in the UE body. The display panel may include a layer of indium tin oxide or a similar compound to enable the display to act as a touchpad. In short, although FIG. 3A illustrates one example of UE 300A, various changes may be made to FIG. 3A without departing from the scope of the disclosure. For example, various components in FIG. 3A can be combined, further subdivided, or omitted and additional components can be added according to particular needs. As one example noted above, the main processor 340 can be divided into multiple processors, such as one or more central processing units (CPUs) and one or more graphics processing units (GPUs). Also, while FIG. 3A may include a UE (e.g., UE 116 in FIG. 1) configured as a mobile telephone or smartphone, UEs can be configured to operate as other types of mobile or stationary devices. For example, UEs may be incorporated in tower desktop computers, tablet computers, notebooks, workstations, and servers.

FIG. 3B shows an example of a BS 300B in accordance with an embodiment. A non-exhaustive example of a BS 300B may be that of BS 102 in FIG. 1. As noted, the terminology BS and gNB may be used interchangeably for purposes of this disclosure. The embodiment of the BS 300B shown in FIG. 3B is for illustration only, and other BSs of FIG. 1 can have the same or similar configuration. However, BSs/gNBs come in a wide variety of configurations, and it should be emphasized that the BS shown in FIG. 3B does not limit the scope of this disclosure to any particular implementation of a BS. For example, BS 101 and BS 103 can include the same or similar structure as BS 102 in FIG. 1 or BS 300B (FIG. 3B), or they may have different structures. As shown in FIG. 3B, the BS 300B includes multiple antennas 370a-370n, multiple corresponding RF transceivers 372a-372n, transmit (TX) processing circuitry 374, and receive (RX) processing circuitry 376. The transceivers 372a-372N are coupled to a processor, directly or through intervening elements. In certain embodiments, one or more of the multiple antennas 370a-370n include 2D antenna arrays. The BS 300B also includes a controller/processor 378 (hereinafter “processor 378”), a memory 380, and a backhaul or network interface 382. The RF transceivers 372a-372n receive, from the antennas 370a-370n, incoming RF signals, such as signals transmitted by UEs or other BSs. The RF transceivers 372a-372n down-convert the incoming respective RF signals to generate IF or baseband signals. The IF or baseband signals are sent to the RX processing circuitry 376, which generates processed baseband signals by filtering, decoding, and/or digitizing the baseband or IF signals. The RX processing circuitry 376 transmits the processed baseband signals to the controller/processor 378 for further processing. The TX processing circuitry 374 receives analog or digital data (such as voice data, web data, e-mail, interactive video game data, or data used in a machine learning program, etc.) from the processor 378. The TX processing circuitry 374 encodes, multiplexes, and/or digitizes the outgoing baseband data to generate processed baseband or IF signals. The RF transceivers 372a-372n receive the outgoing processed baseband or IF signals from the TX processing circuitry 374 and up-convert the baseband or IF signals to RF signals that are transmitted via the antennas 370a-370n. It should be noted that the above is descriptive in nature; in actuality not all antennas 370-370n need be simultaneously active.

The processor 378 can include one or more processors or other processing devices that control the overall operation of the BS 300B. For example, the processor 378 can control the reception of forward channel signals and the transmission of reverse channel signals by the RF transceivers 372a-372n, the RX processing circuitry 376, and the TX processing circuitry 374 in accordance with well-known principles. As another example, the processor 378 could support mobility in wireless networks. The processor 378 can support additional functions as well, such as more advanced wireless communication functions. For instance, the processor 378 can perform the blind interference sensing (BIS) process, such as performed by a BIS algorithm, and decode the received signal subtracted by the interfering signals. Any of a wide variety of other functions can be supported in the BS 300B by the processor 378. In some embodiments, the processor 378 includes at least one microprocessor or microcontroller, or an array thereof. The processor 378 is also capable of executing programs and other processes resident in the memory 380, such as a basic operating system (OS). The processor 378 is also capable of supporting other processes in wireless communication systems as described in embodiments of the present disclosure. In some embodiments, the controller/processor 378 supports communications between entities, such as web real-time communication (web RTC). The processor 378 can move data into or out of the memory 380 as required by an executing process. A backhaul or network interface 382 allows the BS 300B to communicate with other devices or systems over a backhaul connection or over a network. The interface 382 can support communications over any suitable wired or wireless connection(s). For example, when the BS 300B is implemented as part of a cellular communication system (such as one supporting 5G, 5G-A, LTE, or LTE-A, etc.), the interface 382 can allow the BS 102 (FIG. 1) to communicate with other BSs over a wired or wireless backhaul connection. Referring back to FIG. 3B, the interface 382 can allow the BS 102 to communicate over a wired or wireless local area network or over a wired or wireless connection to a larger network (such as the Internet). The interface 382 includes any suitable structure supporting communications over a wired or wireless connection, such as an Ethernet or RF transceiver. The memory 380 is coupled to the processor 378. Part of the memory 380 can include a RAM, and another part of the memory 380 can include a Flash memory or other ROM. In certain exemplary embodiments, a plurality of instructions, such as a Bispectral Index Algorithm (BIS) may be stored in memory. The plurality of instructions are configured to cause the processor 378 to perform the BIS process and to decode a received signal after subtracting out at least one interfering signal determined by the BIS algorithm.

As described in more detail below, the transmit and receive paths of the BS 102 (implemented in the example of FIG. 3B as BS 300B using the RF transceivers 372a-372n, TX processing circuitry 374, and/or RX processing circuitry 376) support communication with aggregation of frequency division duplex (FDD) cells or time division duplex (TDD) cells, or some combination of both. That is, communications with a plurality of UEs can be accomplished by assigning the uplink transmission to a certain frequency and establishing the downlink transmission using a different frequency (FDD). In TDD, the uplink and downlink divisions are accomplished by allotting certain times for uplink transmission to the BS and other times for downlink transmission from the BS to a UE. Although FIG. 3B illustrates one example of a BS 300B which may be similar or equivalent to BS 102 (FIG. 1), various changes may be made to FIG. 3B. For example, the BS 300B can include any number of each component shown in FIG. 3B. As a particular example, an access point can include multiple interfaces 382, and the processor 378 can support routing functions to route data between different network addresses. As another example, while described relative to FIG. 3B for simplicity as including a single instance of TX processing circuitry 374 and a single instance of RX processing circuitry 376, the BS 300B can include multiple instances of each (such as one TX processing circuitry 374 or RX processing circuitry 376 per RF transceiver).

As an example, Release 13 of the LTE standard supports up to 16 CSI-RS [channel status information-reference signal] antenna ports which enable a BS to be equipped with a large number of antenna elements (such as 64 or 128). In this case, a plurality of antenna elements is mapped onto one CSI-RS port. Furthermore, up to 32 CSI-RS ports are supported in Rel.14 LTE. For 5G and the next generation cellular systems such as 6G, the maximum number of CSI-RS ports may be greater. The CSI-RS is a type of reference signal transmitted by the BS to the UE to allow the UE to estimate the downlink radio channel quality. The CSI-RS can be transmitted in any available OFDM symbols and subcarriers as configured in the radio resource control (RRC) message. The UE measures various radio channel qualities (time delay, signal-to-noise ratio, power, etc.) and reports the results to the BS.

The BS 300B of FIG. 3B may also include additional or different types of memory 380, including dynamic random-access memory (DRAM), non-volatile flash memory, static RAM (SRAM), different levels of cache memory, etc. While the main processor 378 may be a complex-instruction set computer (CISC)-based processor with one or multiple cores, in other embodiments, the processor may include a plurality or an array of processors. Often in embodiments, the processing power and requirements of the BS may be much higher than that of the typical UE, although this is not required. Some BSs may include a large structure on a tower or other structure, and their immobility accords them access to fixed power without the need for any local power except backup batteries in a blackout-type event. The processor(s) 378 may also include a reduced instruction set computer (RISC)-based processor or an array thereof. The various other components of BS 300B may include separate processors, or they may be controlled in part or in full by firmware or middleware. For example, any one or more of the components of BS 300B may include one or more digital signal processors (DSPs) for executing specific tasks, one or more field programmable gate arrays (FPGAs), one or more programmable logic devices (PLDs), one or more application specific integrated circuits (ASICs) and/or one or more systems on a chip (SoC) for executing the various tasks discussed above. In some implementations, the BS 300B may rely on middleware or firmware, updates of which may be received from time to time. In some configurations, the BS may include layers of stacked motherboards to accommodate larger processing needs, and to process channel state information (CSI) and other data received from the UEs in the vicinity.

In short, although FIG. 3B illustrates one example of a BS, various changes may be made to FIG. 3B without departing from the scope of the disclosure. For example, various components in FIG. 3B can be combined, further subdivided, or omitted, and additional components can be added according to particular needs. As one example noted above, the main processor 378 can be divided into multiple processors, such as one or more central processing units (CPUs) and one or more graphics processing units (GPUs)—or in some cases, multiple motherboards for enhanced functionality. The BS may also include substantial solid-state drive (SSD) memory, or magnetic hard disks to retain data for prolonged periods. Also, while one example of BS 300B was that of a structure on a tower, this depiction is exemplary only, and the BS may be present in other forms in accordance with well-known principles.

A description of various aspects of the disclosure is provided below. The text in the written description and corresponding figures are provided solely as examples to aid the reader in understanding the principles of the disclosure. They are not intended and are not to be construed as limiting the scope of this disclosure in any manner. Although certain embodiments and examples have been provided, it will be apparent to those skilled in the art based on the disclosures herein that changes in the embodiments and examples shown may be made without departing from the scope of this disclosure.

Aspects, features, and advantages of the disclosure are readily apparent from the following detailed description. Several embodiments and implementations are shown for illustrative purposes. The disclosure is also capable of further and different embodiments, and its several details can be modified in various obvious respects, all without departing from the spirit and scope of the disclosure. Accordingly, the drawings and description are to be regarded as illustrative in nature, and not as restrictive. The disclosure is illustrated by way of example, and not by way of limitation, in the figures of the accompanying drawings.

Although exemplary descriptions and embodiments to follow employ orthogonal frequency division multiplexing (OFDM) or orthogonal frequency division multiple access (OFDMA) for purposes of illustration, other encoding/decoding techniques may be used. That is, this disclosure can be extended to other OFDM-based transmission waveforms or multiple access schemes such as filtered OFDM (F-OFDM). In addition, the principles of this disclosure are equally applicable to different encoding and modulation methods altogether. Examples include LDPC, QPSK, BPSK, QAM, and others.

This present disclosure covers several components which can be used in conjunction or in combination with one another, or which can operate as standalone schemes. Given the sheer volume of terms and vernacular used in conveying concepts relevant to wireless communications, practitioners in the art have formulated numerous acronyms to refer to common elements, components, and processes. For the reader's convenience, a non-exhaustive list of example acronyms is set forth below. As will be apparent in the text that follows, a number of these acronyms below and in the remainder of the document may be newly created by the inventor, while others may currently be familiar. For example, certain acronyms may be formulated by the inventors and designed to assist in providing an efficient description of the unique features within the disclosure. A list of both common and unique acronyms follows.

The following documents are hereby incorporated by reference in their entirety into the present disclosure as if fully set forth herein: i) 3GPP, TS 38.300 v18.0.0, 5G; NR; NR and NG-RAN Overall Description; Stage 2; ii) 3GPP TS 38.331 v18.0.0, 5G; NR; Radio Resource Control (RRC) protocol specification; iii) 3GPP TS 38.321 v18.0.0, NR; Medium Access Control (MAC) protocol specification; iv) 3GPP, TS 38.304 v18.2.0, NR; User Equipment (UE) procedures in Idle mode and RRC Inactive state; v) 3GPP, TS 38.306 v18.2.0, NR; User Equipment (UE) radio access capabilities; and vi) TS 23.041 v18.5.0, Technical Specification Group Core Network and Terminals; Technical realization of Cell Broadcast Service (CBS).

In NTN, the NTN payload may be in geosynchronous orbit (GSO) (i.e. earth-centered orbit at approximately 35,786 kilometers above Earth's surface and synchronized with Earth's rotation), or in non-geosynchronous orbit (NGSO) (i.e. Low Earth Orbit (LEO) at altitude approximately between 300 km and 1,500 km or Medium Earth Orbit (MEO) at altitude approximately between 7000 km and 25,000 km). Depending on different NTN payloads, three types of service links are supported:
Earth-fixed: provisioned by beam(s) continuously covering the same geographical areas all the time (e.g., the case of GSO satellites);
Quasi-Earth-fixed: provisioned by beam(s) covering one geographic area for a limited period and a different geographic area during another period (e.g., the case of NGSO satellites generating steerable beams); and
Earth-moving: provisioned by beam(s) whose coverage area slides over the Earth surface (e.g., the case of NGSO satellites generating fixed or non-steerable beams).

With NGSO satellites, the gNB may provide either quasi-Earth-fixed cell coverage or Earth-moving cell coverage, while gNB operating with GSO satellite may provide Earth fixed cell coverage. A UE may support specific features or functionalities for radio access specific to an NTN payload/cell.

As mentioned, public warning system (PWS) provides a service that allows the network to distribute warning messages on behalf of public authority. For example, PWS enables the distribution of earthquake and tsunami warning system (ETWS), commercial mobile alert service (CMAS) (also known as wireless emergency alerts (WEA) in US), Korean Public Alert System (KPAS) and EU-Alert warning messages in GSM, UMTS, E-UTRAN, and NG RAN. NR connected to 5GC provides support for PWS by means of system information broadcasting. NR is responsible for scheduling and broadcasting of the warning messages. NR is also responsible for paging the UE to provide indication that NR is broadcasting the warning messages.

ETWS is a PWS developed to meet the regulatory requirements for warning notifications related to earthquake and/or tsunami events. ETWS warning notifications can either be a primary notification (short notification) or secondary notification (providing detailed information).

ETWS primary notification may provide services such as:
convey data which is small enough to be sent quickly on the network.
convey small amount of data to indicate the imminent occurrence of earthquake and tsunami, etc.; and
deliver warning within 4 seconds to the UEs in the notification area even under congestion situation.

ETWS secondary notification may provide services such as:
convey a large amount of data to deliver text, audio to instruct what to do/where to get help;
convey graphical data such as a map indicating the route from present position to evacuation site, timetable of food distribution etc.; and
deliver warning to the UEs in the notification area even under congestion situation.

ETWS Primary Notification has higher priority than Secondary Notification so that the notifications nay be sequenced by the public land mobile network (PLMN) according to priority of notification in case both notifications exist at the same time in PLMN.

CMAS is a public warning system developed for the delivery of multiple, concurrent warning notifications. These messages include CMAS Presidential Level Alerts, CMAS Child Abduction Emergency (e.g. AMBER), Imminent Threat, Public Safety etc.

The gNB may use paging (short message) to inform UEs about ETWS and CMAS indications. The UE monitors ETWS/CMAS indications in its own paging occasion when the UE is in RRC_IDLE and RRC_INACTIVE mode and monitors ETWS/CMAS indications in any paging occasion when in RRC_CONNECTED mode. Paging (short message) indicating ETWS/CMAS notification triggers acquisition of system information (without delaying until the next modification period). Different system information blocks (SIBs) are defined for ETWS primary notification, ETWS secondary notification and CMAS notification:
SIB6 contains an ETWS primary notification. ETWS primary notifications contain small data/information to facilitate quicker delivery.
SIB7 contains an ETWS secondary notification. ETWS secondary notification convey a large amount of data to deliver text, audio to instruct what to do/where to get help, graphical data such as a map indicating the route from present position to evacuation site, timetable of food distribution, etc.
SIB8 contains a Commercial Mobile Alert Service (CMAS) notification

SIB6, SIB7 and SIB8 are mapped to broadcast control channel (BCCH) logical channel. The gNB may broadcast SIB6, SIB7, and SIB9 periodically on DL-SCH or broadcast on-demand on DL-SCH (i.e. upon request from UEs in RRC_IDLE or RRC_INACTIVE mode) or sent in a dedicated manner on DL-SCH to UEs in RRC_CONNECTED mode. System information (SI) messages transmitted on the DL-SCH may carry SIB6, SIB7 and SIB8. SIB1 contains scheduling information for the SI-message carrying the corresponding SIB. The gNB may configure SIB6, SIB7 and SIB8 to be cell specific or area specific, using an indication in SIB1. The cell specific SIB is applicable only within a cell that provides the SIB while the area specific SIB is applicable within an area referred to as SI area, which consists of one or several cells and is identified by systeminformationAreaID.

As mentioned, in NTN, satellite footprint and NTN cell covers a large area which is usually much larger than those covered by TN cells. However, ETWS may be intended for an area smaller than an NTN cell coverage. Disclosed are design signalling and procedure to support geo-fencing for ETWS in NTN. In one embodiment, warning area information is provided for the broadcast ETWS primary and/or secondary notification message. UE may indicate the content of warning message to the user based on whether the location of the UE is inside the warning area indicated by the warning area information.

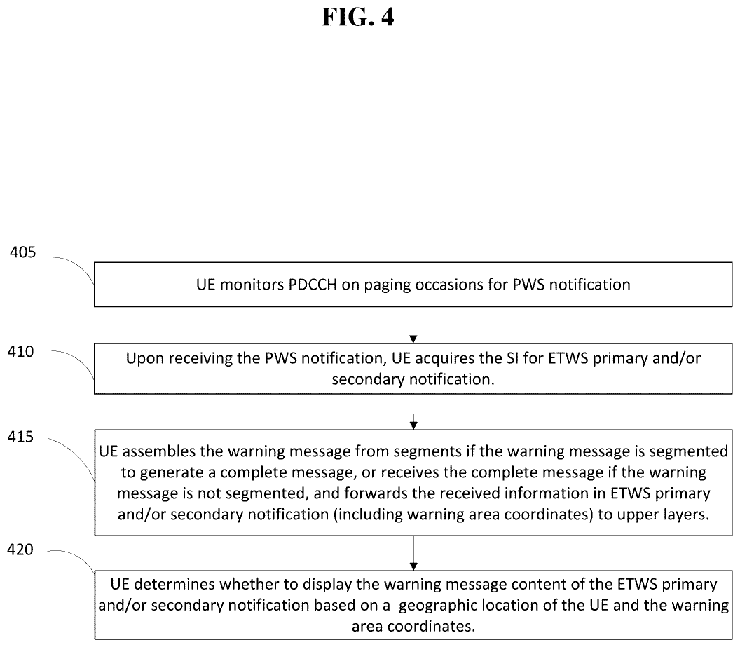

FIG. 4 shows a procedure for the UE to receive ETWS primary or secondary notification with warning area information in accordance with an embodiment.

At operation 405, the UE monitors physical downlink control channel (PDCCH) on paging occasions for PWS notification in the short message transmitted with paging radio network temporary identifier (P-RNTI) over downlink control information (DCI). DCI may include a field to indicate PWS notification. For example, the field (e.g., etwsAndCmasIndication) set to 1 indicates an ETWS primary notification and/or an ETWS secondary notification and/or a CMAS notification.

In one embodiment, when small data transmission (SDT) procedure is not ongoing, ETWS or CMAS capable UEs in RRC_IDLE or in RRC_INACTIVE mode may monitor for indications about PWS notification in its own paging occasion(s) that the UE monitors, as specified in 3GPP Specification TS 38.304. When SDT procedure is ongoing, ETWS or CMAS capable UEs in RRC_INACTIVE mode may monitor for indications about PWS notification in any paging occasion at least once every defaultPagingCycle, if the initial downlink bandwidth part (BWP) on which the SDT procedure is ongoing is associated with a cell-defining synchronization signal block (CD-SSB). In one embodiment, ETWS or CMAS capable UEs in RRC_CONNECTED mode may monitor for indication about PWS notifications in any paging occasion at least once every defaultPagingCycle if the UE is provided with common search space, including pagingSearchSpace, searchSpaceSIB1 and searchSpaceOtherSystemInformation, on the active BWP to monitor paging.

At operation 410, upon receiving the PWS notification, the UE acquires the SI for ETWS primary and/or secondary notification as specified in 3GPP Specification TS 38.331.

In one embodiment, if the ETWS or CMAS capable UE receives a short message, the PWS notification field (etwsAndCmasIndication bit) of the short message is set to 1, and the UE is provided with common search space (e.g., searchSpaceSIB1 and/or searchSpaceOtherSystemInformation) on the active BWP or the initial BWP, the UE may immediately re-acquire the SIB1; if the UE is ETWS capable and si-SchedulingInfo in SIB1 includes scheduling information for the SIB(s) for ETWS primary and/or secondary notification, the UE may acquire the SIB(s) (e.g., SIB6, SIB7) as specified in 3GPP Specification TS 38.331 clause 5.2.2.3.2 immediately.

At operation 415, the UE assembles the warning message from segments if the warning message is segmented and transmitted in several times via SIB (e.g., due to large size of information) to generate a complete message, or alternatively the UE receives the complete message if the warning message is not unsegmented. The UE forwards the complete warning message in ETWS primary and/or secondary notification (including warning area coordinates if any) to upper layers. In one embodiment, upon receiving the SIB(s) (e.g., SIB6, SIB7) for ETWS primary and/or secondary notification the UE forwards the received information including message identifier, serial number, warning type, and/or data coding scheme if any, and/or the warning area coordinates, if any, to upper layers.

In one embodiment, the UE may perform the following operations:
1> if the SIB (e.g., SIB6, SIB7) contains a complete warning message and the complete geographical area coordinates (if any):
   2> forward the received warning message, messageIdentifier, serialNumber, dataCodingScheme and the geographical area coordinates (if any) to upper layers;
   2> continue reception of the SIB (e.g., SIB6, SIB7);
1> else:
   2> if the received values of messageIdentifier and serialNumber are the same (each value is the same) as a pair for which a warning message and the geographical area coordinates (if any) are currently being assembled:
      3> store the received warningMessageSegment;
      3> store the received warningAreaCoordinatesSegment (if any);
      3> if all segments of a warning message and geographical area coordinates (if any) have been received:
         4> assemble the warning message from the received warningMessageSegment;
         4> assemble the geographical area coordinates from the received warningAreaCoordinatesSegment (if any);
         4> forward the received warning message, messageIdentifier, serialNumber, dataCodingScheme and geographical area coordinates (if any) to upper layers;
         4> stop assembling a warning message and geographical area coordinates (if any) for this messageIdentifier and serialNumber and delete all stored information held for it;
      3> continue reception of the SIB (e.g., SIB6, SIB7);
   2> else if the received values of messageIdentifier and/or serialNumber are not the same as any of the pairs for which a warning message is currently being assembled:
      3> start assembling a warning message for this messageIdentifier and serialNumber pair;
      3> start assembling the geographical area coordinates (if any) for this messageIdentifier and serialNumber pair;
      3> store the received warningMessageSegment;
      3> store the received warningAreaCoordinatesSegment (if any);
      3> continue reception of the SIB (e.g., SIB6, SIB7);
In one embodiment, the UE may discard warningMessageSegment and warningAreaCoordinatesSegment (if any) and the associated values of messageIdentifier and serialNumber for the SIB (e.g., SIB6, SIB7) if the complete warning message and the geographical area coordinates (if any) have not been assembled within a certain time period. In one embodiment, this time period may be 3 hours.

In one embodiment, the message identifier (messageIdentifier) parameter (also referred to field) in the SIB identifies the source and type of ETWS notification using 16-bit string. For example:
hex value 1100 indicates Tsunami warning message;
1101 indicates Earthquake warning message;
1102 indicates Tsunami and Earthquake combined warning message;
1103 indicates ETWS test message;
1104 indicates ETWS message related to other emergency types;
1105 indicates ETWS geo-fencing trigger messages.

In one embodiment, the serial number (serialNumber) parameter in the SIB identifies variations of an ETWS primary notification. For example, this parameter may identify a particular ETWS primary notification message from the source and type indicated by the message identifier parameter and may be altered every time the ETWS primary notification message with a given message identifier is changed.

In one embodiment, the warning type parameter in the SIB identifies the warning type of the ETWS primary notification and provides information on emergency user alert and UE popup. It has three fields: warning type value, emergency user alert, and popup indications. The warning type value indicates one of the warning types as its values: earthquake, tsunami, earthquake and tsunami, test, other, and geo-fencing trigger. It may be expressed as 7-bit string. Table 1 below shows the values and their corresponding warning types:

TABLE 1
warning type values and corresponding warning types

| Warning type value | Warning type |
|---|---|
| 0000000 | Earthquake |
| 0000001 | Tsunami |
| 0000010 | Earthquake and Tsunami |
| 0000011 | Test |
| 0000100 | Other |
| 0000101 | Geo-fencing trigger |
| 0000110-1111111 | Reserved for future use |

In one embodiment, the fields for emergency user alert and popup indications are binary type. The emergency user alert and popup indications are used to command mobile terminals to activate emergency user alert and message popup, respectively, to alert the users upon the reception of ETWS primary notification (e.g. paging message). Emergency user alert may include alerting tone and other user alerting means such as vibration, according to the UE's capability. The types of alerts (e.g. the kind of tone, vibration, etc) are implementation dependent and may be subject to regulatory requirements. The values of the fields for the emergency user alert and popup indications are shown in Table 2 below:

TABLE 2
emergency user alert field and popup indication fields

| Field | Emergency User Alert | | Popup Indication | |
|---|---|---|---|---|
| Value | 0 | 1 | 0 | 1 |
| Instruction to | No instruction as | Activate | No instruction | Activate popup |
| Terminal | to emergency user | emergency user | as to popup. | on the display. |
| | alert. | alert. | | |

In one embodiment, the warning area coordinates (also referred to as geographic area coordinates) indicate alert area coordinates of an ETWS warning message. The gNB may optionally provide this information to the UE. If this information is present, the UE uses this information to conditionally display the ETWS warning message contents. In one example of signaling, the warning area may be described by circle(s) and/or polygon(s). A circle is indicated by centre coordinates (e.g., reference location) and a radius. The centre coordinates may be signaled as a bit string, in one of the various formats of ellipsoid point defined in 3GPP Specification TS 37.355 (e.g., Ellipsoid-Point, Ellipsoid-PointWithUncertaintyCircle, EllipsoidPointWithUncertaintyEllipse, EllipsoidPointWithAltitude, EllipsoidPointWithAltitudeAndUncertaintyEllipsoid, etc.). The first/leftmost bit of the first octet contains the most significant bit. The radius indicates a distance from the centre coordinates. The radius may be signaled as an integer value in a unit of meter. A polygon is indicated by a list of polygon points with at least 3 points as defined in 3GPP Specification TS 37.355, where each point is indicated by an ellipsoid point (e.g., Ellipsoid-Point) as defined in 3GPP Specification TS 37.355.

In one embodiment, the data coding scheme (dataCodingScheme) parameter in the SIB identifies the alphabet/coding and the language applied variations of an ETWS notification. For example, the data coding scheme parameter may be one octet long to indicate the intended handling of the message at the UE, the character set/coding, and the language (when applicable).

In one embodiment, the SIB contains a warningMessageSegmentNumber parameter to indicate the segment number of the ETWS warning message segment contained in the SIB. For example, a segment number of ‘zero’ may correspond to the first segment, ‘one’ may correspond to the second segment, and so on. If warning area coordinates are provided for the warning message, then this field may apply to both the warning message segment and the warning area coordinates segment.

In one embodiment, the warningMessageSegment field in the SIB carries a segment, with one or more octets, of the warning message contents information element (IE) defined in 3GPP Specification TS 38.413. The first octet of the warning message contents IE is equivalent to the first octet of the CB data IE and so on.

In one embodiment, a warningMessageSegmentType parameter in the SIB indicates whether the included ETWS warning message segment is the last segment or not. If warning area coordinates are provided for the warning message, then this field may apply to both the warning message segment and the warning area coordinates segment.

In one embodiment, the warningAreaCoordinatesSegment field, if present in the SIB, carries a segment, with one or more octets, of the geographical area where the ETWS warning message is valid. The first octet of the first warningAreaCoordinatesSegment is equivalent to the first octet of warning area coordinates IE and so on.

At operation 420, the UE determines whether to indicate the warning message content of the ETWS primary and/or secondary notification based on a geographic location of the UE and the warning area coordinates if included in the ETWS primary and/or secondary notification.

In one embodiment, for ETWS primary notification message and ETWS secondary notification message, the UE determines whether to indicate the warning message to the user based on the following conditions:
If the warning area coordinates are present, and if the UE is unable to determine its location, the UE indicates the contents of the warning message to the user.
If the warning area coordinates are present, and if the UE determines it is inside the warning area coordinates, the UE indicates the contents of the warning message to the user.
If the warning area coordinates are present, and if the UE determines it is outside the warning area coordinates, the UE does not indicate the contents of the warning message to the user.

In one embodiment, the UE may store the warning message in a list of warning messages to be checked for geo-fencing during a time interval. In one embodiment, the time interval may be UE implementation-specific and may not be greater than 24 hours. Upon expiration of the time interval, the UE may remove the stored warning message from the list of warning messages to be checked for geo-fencing. If the warning message is a geo-fencing trigger message (see Table 1 above), then the UE may perform the following operations:
If the list of warning messages to be checked for geo-fencing stored at the UE is not empty, the UE may, for each warning message stored at the UE in the list of warning messages to be checked for geo-fencing, compare the serial number and message identifier combination of the stored warning message to the list of serial number and message identifier combinations included in the warning message content IE (CB data) of the geo-fencing trigger message, and:
   1) if the serial number and message identifier combination of the stored warning message matches one of the serial number and message identifier combinations included in the warning message content IE (CB data) of the geo-fencing trigger message:
      a) if the UE is able to determine its location and determines it is inside the warning area coordinates of the stored warning message, or if the UE is unable to determine its location, the UE indicates the contents of the stored warning message to the user, removes the warning message from the list of warning messages to be checked for geo-fencing and then discards the geo-fencing trigger message;
      b) if the UE is able to determine its location and determines it is outside the warning area coordinates of the stored warning message, the UE discards the geo-fencing trigger message.
   2) if none of serial number and message identifier combinations of the stored warning message matches any of the serial number and message identifier combinations included in the warning message content IE (CB data) of the geo-fencing trigger message, the UE discards the geo-fencing trigger message.
If the list of warning messages to be checked for geo-fencing stored at the UE is empty, the UE discards the geo-fencing trigger message

In one embodiment, if the warning area coordinates are not present, the UE determines whether to alert user to the emergency and to popup on display the warning message, respectively, based on the field of emergency user alert and the field of popup indication included in the warning type for the ETWS primary notification message (see Table 2 above).

In one embodiment, if the warning area coordinates are present, the UE ignores the fields for emergency user alert and popup indications included in the warning type for the ETWS primary notification message, and the UE determines whether to indicate the warning message content of the ETWS primary notification based on the UE geographic location and the warning area coordinates as aforementioned.

In one embodiment, if the warning area coordinates are present, and if the fields for emergency user alert and popup indications included in the warning type for the ETWS primary notification message are set to 0 (i.e., no instruction as to emergency alert and to popup, respectively), the UE determines whether to indicate the warning message content of the ETWS primary notification based on the UE geographic location and the warning area coordinates as aforementioned.

In one embodiment, if warning area coordinates are present, the UE first determines whether to indicate the warning message content of the ETWS primary notification based on the UE geographic location and the warning area coordinates as aforementioned. If the UE determines to indicate the contents of the stored warning message to the user, the UE secondly determines whether to alert the user to the emergency and whether to popup on display the warning message based on the indication in the field of emergency user alert and the field of popup indication included in the warning type for the ETWS primary notification message, respectively. Otherwise (i.e., if UE determines to not indicate the contents of the stored warning message to the user), the UE does not process the information included in the warning type (e.g., ignore the warning type information).

In one embodiment, if the warning area coordinates are present, and if the field for emergency user alert included in the warning type for the ETWS primary notification message is set to 1 (i.e., activate emergency user alert), the UE determines whether to alert user to the ETWS primary notification message based on the UE geographic location and the warning area coordinates.

In one embodiment, if the warning area coordinates are present, and if the field for popup on display included in the warning type for the ETWS primary notification message is set to 1 (i.e., activate popup on display), the UE determines whether to popup the ETWS primary notification warning message on display based on the UE geographic location and the warning area coordinates.

In one embodiment, for the ETWS primary notification message, the operations for the UE to alert the user to the emergency or to popup on display the content of the warning message are:
If the field for emergency user alert included in the warning type is set to 1 (i.e., activate emergency user alert), and if the warning area coordinates are not present, the UE alerts the user to the emergency.
If the field for emergency user alert included in the warning type is set to 1 (i.e., activate emergency user alert), and if the warning area coordinates are present, and if the UE is unable to determine its location, the UE alerts the user to the emergency.
If the field for emergency user alert included in the warning type is set to 1 (i.e., activate emergency user alert), and if the warning area coordinates are present, and the UE determines it is inside the warning area coordinates, the UE alerts the user to the emergency.
If the field for emergency user alert included in the warning type is set to 1 (i.e., activate emergency user alert), and if the warning area coordinates are present, and the UE determines it is outside the warning area coordinates, the UE does not alert the user to the emergency.
If the field for popup on display included in the warning type is set to 1 (i.e., activate popup on display), and if the warning area coordinates are not present, the UE popups on display the contents of the warning message to the user.
If the field for popup on display included in the warning type is set to 1 (i.e., activate popup on display), and if the warning area coordinates are present, and if the UE is unable to determine its location, the UE popups on display the contents of the warning message to the user.
If the field for popup on display included in the warning type is set to 1 (i.e., activate popup on display), and if the warning area coordinates are present, and the UE determines it is inside the warning area coordinates, the UE popups on display the contents of the warning message to the user.
If the field for popup on display included in the warning type is set to 1 (i.e., activate popup on display), and if the warning area coordinates are present, and the UE determines it is outside the warning area coordinates, the UE does not popup on display the contents of the warning message to the user

In one embodiment, for the ETWS primary notification, the UE may store the warning message in the list of warning messages to be checked for geo-fencing during a time interval. In one embodiment, the time interval may be UE implementation-specific time and may not be greater than 24 hours. Upon expiration of the time interval, the UE may remove the stored warning message from the list of warning messages to be checked for geo-fencing. If the warning message is a geo-fencing trigger message (see Table 1 above), then the UE may perform the following operations:
If the list of warning messages to be checked for geo-fencing stored at the UE is not empty, the UE may, for each warning message stored at the UE in the list of warning messages to be checked for geo-fencing, compare the serial number and message identifier combination of the stored warning message to the list of serial number and message identifier combinations included in the warning message content IE (CB data) of the geo-fencing trigger, and:
   1) if the serial number and message identifier combination of the stored warning message matches one of the serial number and message identifier combinations included in the warning message content IE (CB data) of the geo-fencing trigger message:
      a) if the UE is able to determine its location and determines it is inside the warning area coordinates of the stored warning message, or if the UE is unable to determine its location,
         the UE alerts the user to the emergency if the field for emergency user alert included in the warning type is set to 1 (i.e., activate emergency user alert), and
         the UE popups on display the contents of the stored warning message to the user if the field for popup on display included in the warning type is set to 1 (i.e., activate popup on display), and
         the UE removes the warning message from the list of warning messages to be checked for geo-fencing and then discards the geo-fencing trigger message;
      b) if the UE is able to determine its location and determines it is outside the warning area coordinates of the stored warning message, the UE discards the geo-fencing trigger message.
   2) if none of serial number and message identifier combinations of the stored warning message matches any of the serial number and message identifier combinations included in the warning message content IE (CB data) of the geo-fencing trigger message, the UE discards the geo-fencing trigger message.
If the list of warning messages to be checked for geo-fencing stored at the UE is empty, the UE discards the geo-fencing trigger message

In one embodiment, if the warning area coordinates are present, and if the field for emergency user alert included in the warning type for the ETWS primary notification message is set to 0 (i.e., no instruction as to emergency alert), the UE does not alert user to the ETWS primary notification message regardless of the warning area coordinates.

In one embodiment, if the warning area coordinates are present, and if the field for popup on display included in the warning type for the ETWS primary notification message is set to 0 (i.e., no instruction as to popup on display), the UE does not popup the ETWS primary notification warning message on display regardless of the warning area coordinates.

In one embodiment, the UE may report its capability for supporting warning area information for PWS (e.g., for ETWS primary and/or secondary notification) to the gNB. A UE may report different capabilities in TN and in NTN. In NTN, when the UE reports this capability, the UE also reports its support of NTN. The UE capability may be defined per UE, per band, or per band combination. The UE capability may be the same between frequency range 1 (FR1) and frequency range 2 (FR2). The UE capability may be the same between time division duplex (TDD) and frequency division duplex (FDD) links.

In one embodiment, the UE decides whether to acquire SI for PWS (e.g., ETWS primary/secondary notification message, CMAS, etc) based on the intended geographic area information (also referred to as intended area information). The UE acquires the UE's location and the intended area information associated with PWS (e.g., ETWS primary/secondary notification message, CMAS, etc). The intended area information associated with PWS (e.g., ETWS primary/secondary notification message, CMAS, etc) may be included in SIB1, and/or in a SIB scheduled by SIB1 (e.g., a new SIB or ETWS primary notification message or ETWS secondary notification message). The intended area information associated with PWS (e.g., ETWS primary/secondary notification message, CMAS, etc) may be indicated by an index representing a geographic area. In one embodiment, the index indication may be included in a short message, and/or in DCI in PDCCH for paging, and/or in SIB1, and/or in a SIB scheduled by SIB1 (e.g., a new SIB or ETWS primary notification message or ETWS secondary notification message).

If the UE location and the intended area information associated with PWS (e.g., ETWS primary/secondary notification message, CMAS, etc) are available, the UE determines whether the UE location is inside the intended area for the PWS (e.g., ETWS primary/secondary notification message, CMAS, etc). If the UE location is inside the intended area for the PWS (e.g., ETWS primary/secondary notification message, CMAS, etc), the UE acquires the PWS (e.g., ETWS, CMAS, etc) in broadcast and/or forwards the received PWS (e.g., ETWS, CMAS, etc) to the upper layer. If the UE location is outside the intended area for the PWS (e.g., ETWS primary/secondary notification message, CMAS, etc), the UE does not acquire the PWS (e.g., ETWS primary/secondary notification message, CMAS, etc) and/or does not forward the received PWS (e.g., ETWS, CMAS, etc) to the upper layer. If the UE's location or the intended area information associated with the PWS (e.g., ETWS primary/secondary notification message, CMAS, etc) is not available, the UE acquires the PWS (e.g., ETWS primary/secondary notification message, CMAS, etc) in broadcast and/or forwards the received PWS (e.g., ETWS, CMAS, etc) to the upper layer.

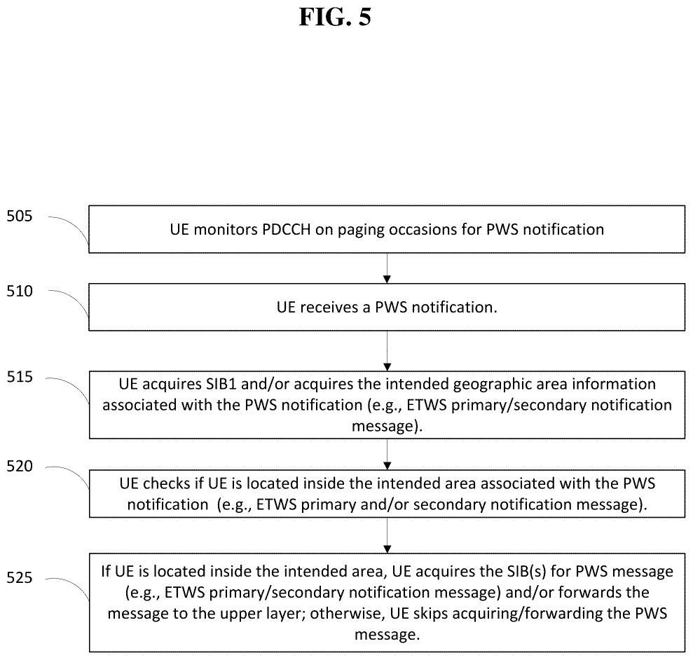

FIG. 5 shows a procedure for the UE to acquire PWS based on the intended geographic area information of the PWS and the UE's geographic location in accordance with an embodiment.

At operation 505, the UE monitors PDCCH on paging occasions for PWS notification. The PWS notification may be in the short message transmitted with P-RNTI over DCI. DCI may include a field to indicate PWS notification. For example, the field (e.g., etwsAndCmasIndication) set to 1 indicates an ETWS primary notification and/or an ETWS secondary notification and/or a CMAS notification.

In one embodiment, when SDT procedure is not ongoing, ETWS or CMAS capable UEs in RRC_IDLE or in RRC_INACTIVE mode may monitor for indications about PWS notification in its own paging occasion(s) that the UE monitors, as specified in 3GPP Specification TS 38.304. When SDT procedure is ongoing, ETWS or CMAS capable UEs in RRC_INACTIVE mode may monitor for indications about PWS notification in any paging occasion at least once every defaultPagingCycle, if the initial downlink bandwidth part (BWP) on which the SDT procedure is ongoing is associated with a CD-SSB. In one embodiment, ETWS or CMAS capable UEs in RRC_CONNECTED mode may monitor for indication about PWS notifications in any paging occasion at least once every if the UE is provided with common search space, including pagingSearchSpace, searchSpaceSIB1 and searchSpaceOtherSystemInformation, on the active BWP to monitor paging.

At operation 510, the UE receives a PWS notification in the short message.

At operation 515, upon receiving the PWS notification, the UE acquires SIB1 and/or acquires the intended area information for the PWS notification (e.g., ETWS primary and/or secondary notification message).

In one embodiment, if the ETWS or CMAS capable UE receives a short message, the PWS notification field (e.g., etwsAndCmasIndication bit) of the short message is set to 1, and the UE is provided with common search space (e.g., searchSpaceSIB1 and/or searchSpaceOtherSystemInformation) on the active BWP or the initial BWP, the UE may immediately re-acquire the SIB1.

In one embodiment, the intended area information associated with ETWS primary/secondary notification message is included in SIBL. If the UE is ETWS capable and/or supports warning area information for ETWS primary and/or secondary notification and/or if UE's location is available, the UE identifies the intended area information associated with ETWS primary and/or secondary notification message in SIB1.

In one embodiment, the intended area information associated with ETWS primary/secondary notification message is included in a SIB scheduled by SIB1 (e.g., a new SIB or ETWS primary notification message). If the UE is ETWS capable and/or supports warning area information for ETWS primary and/or secondary notification and/or if UE location is available and/or if si-SchedulingInfo in SIB1 includes scheduling information for the SIB(s) containing the intended area information associated with ETWS primary and/or secondary notification message, the UE acquires the SIB(s) containing the intended area information associated with ETWS primary and/or secondary notification message immediately.

In one embodiment, a list of geographic areas associated with ETWS primary/secondary notification message, with each area identified by an index, is included in SIB1 or in a SIB scheduled by SIB1 (e.g., a new SIB or the SIB for ETWS primary and/or secondary notification message). The short message containing the PWS notification (or the DCI in PDCCH for paging) contains a field for the index of the geographic area intended for the ETWS primary/secondary notification message. If the UE is ETWS capable and/or supports warning area information for ETWS primary and/or secondary notification, and/or if UE location is available, and/or if si-SchedulingInfo in SIB1 includes scheduling information for the SIB(s) containing geographic areas associated with ETWS primary and/or secondary notification message, the UE acquires the scheduled SIB(s), and/or the UE identifies the intended area based on the indicated index of the geographic area intended for the ETWS primary and/or secondary notification message.

In one embodiment, a list of geographic areas associated with ETWS primary/secondary notification message, with each area identified by an index, and/or the index of the geographic area intended for the ETWS primary/secondary notification message, may be included in SIB1 or in a SIB scheduled by SIB1 (e.g., a new SIB or the SIB for ETWS primary and/or secondary notification message). If the UE is ETWS capable and/or supports warning area information for ETWS primary and/or secondary notification, and/or if the UE location is available, and/or if si-SchedulingInfo in SIB1 includes scheduling information for the SIB(s) containing the index of the geographic area intended for the ETWS primary and/or secondary notification message and/or containing geographic areas associated with ETWS primary/secondary notification message, the UE acquires the scheduled SIB(s), and/or UE identifies the intended area based on the indicated index of the geographic area intended for the ETWS primary and/or secondary notification message.

At operation 520, the UE checks if the UE is located inside the intended area associated with the PWS notification (e.g., ETWS primary and/or secondary notification message).

At operation 525, if the UE is inside the intended area associated with the ETWS primary and/or secondary notification message and if si-SchedulingInfo in SIB1 includes scheduling information for the SIB(s) for ETWS primary and/or secondary notification, the UE acquires the SIB(s) (e.g., SIB6, SIB7) for ETWS primary and/or secondary notification as specified in 3GPP Specification TS 38.331 clause 5.2.2.3.2 immediately, and/or the UE forwards the ETWS primary and/or secondary notification to the upper layer. If the UE is outside the intended area associated with the ETWS primary and/or secondary notification message, the UE ignore the PWS notification in the short message and/or skips acquiring the SIB(s) (e.g., SIB6, SIB7) for ETWS primary and/or secondary notification, and/or the UE skips forwarding the ETWS primary and/or secondary notification to the upper layer. If the intended area information (e.g., list of geographic areas, index of the intended area, etc.) associated with ETWS primary and/or secondary notification message is not available or if UE location is not available, if si-SchedulingInfo in SIB1 includes scheduling information for the SIB(s) for ETWS primary and/or secondary notification, the UE acquires the SIB(s) (e.g., SIB6, SIB7) for ETWS primary and/or secondary notification as specified in 3GPP Specification TS 38.331 clause 5.2.2.3.2 immediately, and/or the UE forwards the ETWS primary and/or secondary notification to the upper layer.

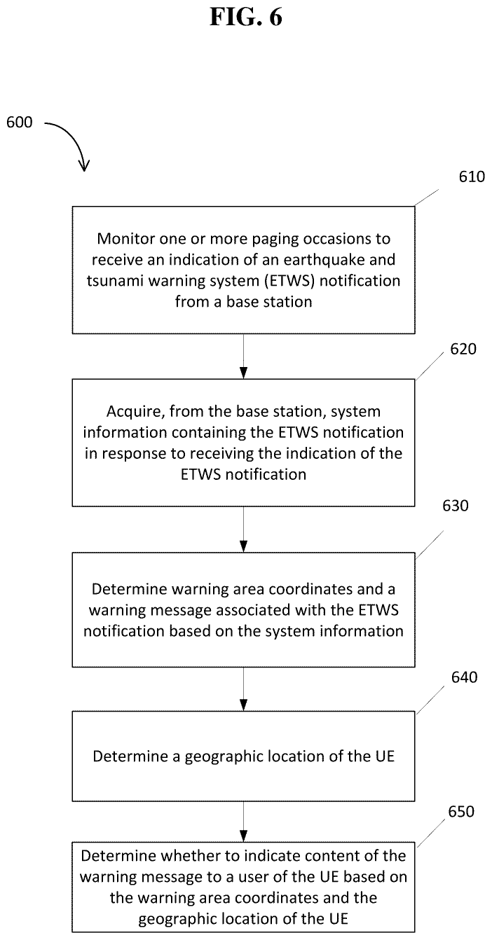

FIG. 6 shows an example process 600 for a UE to receive ETWS notification including warning area coordinates to support geo-fencing functionality of the ETWS notification in accordance with an embodiment. For explanatory and illustration purposes, the example processes 600 may be performed by a UE (e.g., UE 111-116 as described with reference to FIG. 1). Although one or more operations are described or shown in particular sequential order, in other embodiments the operations may be rearranged in a different order, which may include performance of multiple operations in at least partially overlapping time periods

Referring to FIG. 6, the process 600 may begin in operation 610. In operation 610, a UE (e.g., a processor of the UE) monitors one or more paging occasions to receive an indication of an ETWS notification from a base station. In one embodiment, UE monitors PDCCH on paging occasions for PWS notification in the short message transmitted with P-RNTI over DCI. DCI may include a field (e.g., etwsAndCmasIndication) to indicate ETWS notification.

In operation 620, the UE acquires, from the base station, system information (SI) containing the ETWS notification in response to receiving the indication of the ETWS notification. In one embodiment, the UE re-acquires the SIB1 if the UE is provided with common search space on the active BWP or the initial BWP. If the SIB1 includes scheduling information for the SIB(s) for ETWS primary and/or secondary notification, the UE may acquire the SIB(s) (e.g., SIB6, SIB7).

In operation 630, the UE determines warning area coordinates and a warning message associated with the ETWS notification based on the system information. In one embodiment, the UE assembles the warning message and the warning area coordinates associated with the ETWS notification from segments, if the warning message and the warning area coordinates are segmented and transmitted several times via SIB (e.g., due to large size of information), to generate a complete warning message and a complete set of warning area coordinates. In one embodiment, the UE receives the complete message and the complete set of warning area coordinates if the warning message and the warning area coordinates are not unsegmented. In one embodiment, the warning area coordinates indicate a geographical area where the warning message associated with the ETWS notification is valid.

In operation 640, the UE determines a geographic location of the UE.

In operation 650, the UE determines whether to indicate content of the warning message to a user of the UE based on the warning area coordinates and the geographic location of the UE. In one embodiment, if the UE determines it is inside the geographical area of the warning message based on the warning area coordinates, the UE indicates the contents of the warning message to the user. Otherwise, if the UE determines it is outside the geographical area of the warning message based on the warning area coordinates, the UE does not indicate the contents of the warning message to the user. In one embodiment, the ETWS notification includes an indication to activate an emergency user alert or to activate a popup display on the UE. In one embodiment, if the UE determines it is inside the geographical area of the warning message or the geographic location of the UE is unknown, the UE alerts the user of the UE to the ETWS emergency or displays the warning message on the UE through a popup. In one embodiment, if the UE determines it is outside the geographical area of the warning message, the UE does not alert the user of the UE to the ETWS emergency or does not display the warning message on the UE.

The disclosure presents design signalling and procedure to support geo-fencing for ETWS in NTN. In one embodiment, warning area information is provided for the broadcast ETWS primary and/or secondary notification message. The warning area information indicates the geographical area where the ETWS primary and/or secondary notification message is valid. The UE may indicate the content of warning message to the user based on whether the location of the UE is inside the warning area indicated by the warning area information.

In one embodiment, the UE decides whether to acquire SI for ETWS primary/secondary notification message based on the intended geographic area information of the ETWS notification message and the UE's geographic location. If the UE's location is inside the intended geographic area for the ETWS notification, the UE acquires the ETWS notification. Otherwise, if the UE's location is outside the intended geographic area for the ETWS notification, the UE does not acquire the ETWS notification.

Advantageously, using the disclosed signalling and procedure to support geo-fencing for ETWS in NTN, ETWS warning messages may be directed specifically to UEs within an intended area, such as a country, allowing the ETWS warning message to be targeted to a geographical area smaller than an NTN cell coverage area.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the disclosure. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems may generally be integrated together in a single software/hardware product or packaged into multiple software/hardware products.

The disclosure is provided to enable any person skilled in the art to practice the various aspects described herein. In some instances, well-known structures and components are shown in block diagram form to avoid obscuring the concepts of the subject technology. The disclosure provides myriad examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, the detailed description provides illustrative examples, and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A user equipment (UE) in a wireless network, the UE comprising:
a processor configured to:
monitor one or more paging occasions to receive an indication of an earthquake and tsunami warning system (ETWS) notification from a base station;
acquire, from the base station, system information containing the ETWS notification in response to receiving the indication of the ETWS notification;
determine warning area coordinates and a warning message associated with the ETWS notification based on the system information;
determine a geographic location of the UE; and
determine whether to indicate content of the warning message to a user of the UE based on the warning area coordinates and the geographic location of the UE.

2. The UE of claim 1, wherein the system information comprises one or more segments of the ETWS notification, and wherein each segment of the ETWS notification comprises:
a segment of the warning message; and
a segment of the warning area coordinates.

3. The UE of claim 2, wherein to acquire the system information containing the ETWS notification, the processor is configured to receive the one or more segments of the ETWS notification, and wherein to determine the warning area coordinates and the warning message, the processor is configured to:
assemble one or more segments of the warning message to generate a complete warning message; and
assemble one or more segments of the warning area coordinates to generate a complete set of warning area coordinates.

4. The UE of claim 3, wherein to assemble the one or more segments of the warning area coordinates, the processor is configured to:
store the one or more segments of the warning area coordinates when receiving the respective one or more segments of the ETWS notification;
generate the complete set of warning area coordinates from the one or more segments of the warning area coordinates that are stored when all segments of the warning area coordinates are received;
forward the complete set of warning area coordinates to an upper layer of the UE; and
discard the one or more segments of the warning area coordinates that are stored.

5. The UE of claim 1, wherein the warning area coordinates indicate a geographical area where the warning message associated with the ETWS notification is valid.

6. The UE of claim 1, wherein to determine whether to indicate the content of the warning message to the user, the processor is configured to:
determine a geographical area of the warning message based on the warning area coordinates;
determine the geographic location of the UE is unknown; and
indicate the content of the warning message to the user of the UE.

7. The UE of claim 1, wherein to determine whether to indicate the content of the warning message to the user, the processor is configured to:
determine a geographical area of the warning message based on the warning area coordinates;
determine the geographic location of the UE is inside the geographical area of the warning message; and
indicate the content of the warning message to the user of the UE.

8. The UE of claim 1, wherein to determine whether to indicate the content of the warning message to the user, the processor is configured to:
determine a geographical area of the warning message based on the warning area coordinates;
determine the geographic location of the UE is outside the geographical area of the warning message; and
refrain from indicating the content of the warning message to the user of the UE.

9. The UE of claim 1, wherein the ETWS notification comprises an indication to activate an emergency user alert or to activate a popup display on the UE, and wherein to determine whether to indicate the content of the warning message to the user, the processor is configured to:
determine a geographical area of the warning message based on the warning area coordinates;
determine the geographic location of the UE is inside the geographical area of the warning message or the geographic location of the UE is unknown; and
alert the user of the UE to an ETWS emergency or popup a display of the warning message on the UE.

10. The UE of claim 1, wherein the ETWS notification comprises an indication to activate an emergency user alert or to activate a popup display on the UE, and wherein to determine whether to indicate the content of the warning message to the user, the processor is configured to:
determine a geographical area of the warning message based on the warning area coordinates;
determine the geographic location of the UE is outside the geographical area of the warning message; and
refrain from alerting the user of the UE to an ETWS emergency or refrain from displaying the warning message on the UE.

11. A method performed by a user equipment (UE) in a wireless network, the method comprising:
monitoring one or more paging occasions to receive an indication of an earthquake and tsunami warning system (ETWS) notification from a base station;
acquiring, from the base station, system information containing the ETWS notification in response to receiving the indication of the ETWS notification;
determining warning area coordinates and a warning message associated with the ETWS notification based on the system information;
determining a geographic location of the UE; and
determining whether to indicate content of the warning message to a user of the UE based on the warning area coordinates and the geographic location of the UE.

12. The method of claim 11, wherein the system information comprises one or more segments of the ETWS notification, and wherein each segment of the ETWS notification comprises:
a segment of the warning message; and
a segment of the warning area coordinates.

13. The method of claim 12, wherein acquiring the system information containing the ETWS notification comprises:
receiving the one or more segments of the ETWS notification, and wherein determining the warning area coordinates and the warning message comprises:
assembling one or more segments of the warning message to generate a complete warning message; and
assembling one or more segments of the warning area coordinates to generate a complete set of warning area coordinates.

14. The method of claim 13, wherein assembling one or more segments of the warning area coordinates comprises:
storing the one or more segments of the warning area coordinates when receiving the respective one or more segments of the ETWS notification;
generating the complete set of warning area coordinates from the one or more segments of the warning area coordinates that are stored when all segments of the warning area coordinates are received;
forwarding the complete set of warning area coordinates to an upper layer of the UE; and
discarding the one or more segments of the warning area coordinates that are stored.

15. The method of claim 11, wherein the warning area coordinates indicate a geographical area where the warning message associated with the ETWS notification is valid.

16. The method of claim 11, wherein determining whether to indicate the content of the warning message to the user of the UE comprises:
determining a geographical area of the warning message based on the warning area coordinates;
determining the geographic location of the UE is unknown; and
indicating the content of the warning message to the user of the UE.

17. The method of claim 11, wherein determining whether to indicate the content of the warning message to the user of the UE comprises:
determining a geographical area of the warning message based on the warning area coordinates;
determining the geographic location of the UE is inside the geographical area of the warning message; and
indicating the content of the warning message to the user of the UE.

18. The method of claim 11, wherein determining whether to indicate the content of the warning message to the user of the UE comprises:
determining a geographical area of the warning message based on the warning area coordinates;
determining the geographic location of the UE is outside the geographical area of the warning message; and
refraining from indicating the content of the warning message to the user of the UE.

19. The method of claim 11, wherein the ETWS notification comprises an indication to activate an emergency user alert or to activate a popup display on the UE, and wherein determining whether to indicate the content of the warning message to the user of the UE comprises:
determining a geographical area of the warning message based on the warning area coordinates;
determining the geographic location of the UE is inside the geographical area of the warning message or the geographic location of the UE is unknown; and
alerting the user of the UE to an ETWS emergency or popping up a display of the warning message on the UE.

20. The method of claim 11, wherein the ETWS notification comprises an indication to activate an emergency user alert or to activate a popup display on the UE, and wherein determining whether to indicate the content of the warning message to the user of the UE comprises:
determining a geographical area of the warning message based on the warning area coordinates;
determining the geographic location of the UE is outside the geographical area of the warning message; and
refraining from alerting the user of the UE to an ETWS emergency or refraining from displaying the warning message on the UE.
